(19) United States
(12) Patent Application Publication
(10) Pub. No.: US 2008/0024264 A1
(43) Pub. Date: Jan. 31, 2008

(54) METAL OXIDE VARISTOR

(75) Inventor: Walter A. SCHILLOFF, Endicott, NY (US)

Correspondence Address: LOCKE LIDDELL & SAPP LLP;ATTN: IP DOCKETING, 600 TRAVIS STREET, 3400 CHASE TOWER, HOUSTON, TX, 77002, US

(73) Assignee: EMERSON ELECTRIC CO., St. Louis, MO (US)

(21) Appl. No.: 11/459,716

(22) Filed: Jul. 25, 2006

(51) Int. Cl. H01C 7/10

(52) U.S. Cl. 338/21

(57) ABSTRACT

The present disclosure includes a varistor that protects a system from abnormal energy transients. The varistor has a core, a first electrode, a second electrode, a first electrical lead, and a second electrical lead. The core has a first flat side and a second flat side as well as opposing first and second outer side regions. The first electrode is deposited on a majority of the first flat side of the core and has a center region and an outer region. The second electrode is deposited on a majority of the second flat side of the core and has a center region and an outer region. The first electrical lead is attached to the outer region of the first electrode at a first attachment point. The second electrical lead is attached to the outer region of the second electrode at a second attachment point. The first attachment point is adjacent to the first outer side region of the core and the second attachment point is adjacent to the second outer side region of the core. The invention also includes a method of making such a varistor.

### CROSS REFERENCE TO RELATED APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO APPENDIX

Not applicable.

### BACKGROUND

1. Field of the Invention

This application relates generally to Metal Oxide Varistors (MOVs) and more particularly to a MOV that reduces the chances of shorting when the MOV physically destructs.

2. Description of Related Art

MOVs are typically employed to protect a system or equipment by preventing exposure to overvoltage conditions or abnormal energy transients caused by sources including lightning, inductive switching, electrostatic discharge, and unbalanced wye configurations. A MOV reacts to overvoltage conditions or abnormal energy transients to protect the equipment by clamping the voltage applied to the equipment to an acceptable voltage level. In general, a MOV is a two-terminal device that is rendered conductive when the voltage across its terminals exceeds a threshold value and that, when conductive, tends to maintain a voltage across its terminals that is close to the threshold voltage.

Because of the nature of transients, MOVs may be required to handle a tremendous amount of energy over a very brief period of time. For example, if the excess energy is generated by a very large energy source then the MOV must dissipate or otherwise handle the energy remaining after the energy on the protected line is clamped to the threshold level.

MOVs are typically transparent as possible to system operation until needed to absorb excess energy. Thus, under normal system operation, MOVs exhibit an open, or high impedance state. Upon detection of intolerably high voltage (i.e. the clamping voltage of the MOV), MOVs exhibit a low impedance state. Increased current is drawn into the MOV due to its decreased impedance. The excessive energy shunted away from the load is received and partly or wholly absorbed by the MOV. However, MOVs are limited in the amount of energy that they may receive short of failure.

MOVs fail when they shunt too much energy. MOVs are typically designed to shunt a very large current for a very short period of time. There are no currently marketed MOVs capable of shunting a large current for a moderate to large period of time. Accordingly, one of the failure modes of MOVs is actual physically destruction. As explained below, the current design of MOVs may result in a short circuit if the MOV physically destructs. This occurs when the electrical leads touch each other when the MOV physically destructs.

A common type of MOV that exhibits this problem is a MOV having a radial lead package. A MOV having a radial lead package is shown U.S. Pat. No. 4,538,347.

As shown in FIGS. 1 and 2, a MOV 10 having a radial lead package includes an inner core 20, electrodes 22, electrical lead wires 26, and protective coating 30. The inner core 20 is typically in the shape of a disc and made of a zinc oxide with small additions of bismuth, cobalt, manganese and other metal oxides. The inner core 20 made be fabricated by forming and sintering zinc oxide based powders into ceramic parts. After the ceramic inner core 20 is formed, electrodes 22 are deposited onto the two flat surfaces 24 of the disc-shaped inner core 20. The electrodes 22 may be formed by electroding the flat surfaces 24 of the inner core 20 with either thick film silver or arc/flame sprayed metal. Electrical leads 26 are then soldered to the electrodes 22 on each side of the inner core 20 with a soldering material 28. In existing MOVs, the electrical leads 26 are positioned such that the electrical leads 26 extend into the center region of the electrodes 22 as shown in FIG. 1. An epoxy based coating 30 is then applied to the outer surfaces of the assembly of inner core 20, electrodes 22 and electrical leads 26.

The problem with the current design of existing MOVs is that when there is a destructive failure, it has been shown that the electrical leads 26 may touch creating a short circuit. This is caused by the close proximity of the electrical leads 26. The present invention reduces the chances of this problem.

In the past, the prior art has tried to avoid this problem by protecting the MOV with a fuse. The fuse is placed in series with the MOV. This requires, however, another component in the system resulting in additional cost and requiring additional space on a mounting surface of the system such as a printed circuit board.

Thus, a need exists for alternative ways to reduce the problem of shorting when the MOV destructs without adding additional components to the system.

### BRIEF SUMMARY

In accordance with the present disclosure, a varistor is provided for protecting a system from abnormal energy transients. The varistor has a core, a first electrode, a second electrode, a first electrical lead, and a second electrical lead. The core has a first flat side and a second flat side as well as opposing first and second outer side regions. The first electrode is deposited on a majority of the first side of the core and has a center region and an outer region. The second electrode is deposited on a majority of the second side of the core and has a center region and an outer region. The first electrical lead is attached to the outer region of the first electrode at a first attachment point. The second electrical lead is attached to the outer region of the second electrode at a second attachment point. The first attachment point is adjacent to the first outer side region of the core and the second attachment point is adjacent to the second outer side region of the core.

The first and second electrical leads can be straight and at the farthest points of the electrodes. The core can be of different shapes such as generally circular, rectangular, or oval.

In another embodiment, the present invention also includes a varistor having a core, a first electrode, a second electrode, a first electrical lead and a second electrical lead. Here, however, the portions of the first and second electrical leads that attach to the electrodes should be unbent. The attachment points of the leads are positioned at opposite sides of the varistor.

A further embodiment includes a method of making a varistor for protecting a system from abnormal energy transients. The method includes: providing a metal oxide core for absorbing energy transients, the core having a first flat side and a second flat side; depositing a first electrode on a substantial portion of the first side of the core, the first electrode having a center region and an outer regions; depositing a second electrode on a substantial portion of the second side of the core, the second electrode having a center region and an outer region; attaching a first electrical lead to the outer region of the first electrode; attaching a second electrical lead to the outer region of the second electrode; and applying a protective coating over the metal oxide core, the first electrode, the second electrode, and portions of the first and second leads.

### BRIEF DESCRIPTION OF THE DRAWINGS

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art as required by 35 U.S.C. § 112.

FIG. 1 is a front schematic view of a typical prior art MOV.

FIG. 2 is a side schematic view of the prior art MOV of FIG. 1.

FIG. 3 is a front schematic view of an exemplary MOV of the present disclosure.

FIG. 4 is a side schematic view of the MOV of FIG. 3.

FIG. 5 is a front schematic view of an alternative exemplary MOV of the present disclosure.

FIG. 6 is a front schematic view of another alternative exemplary MOV of the present disclosure.

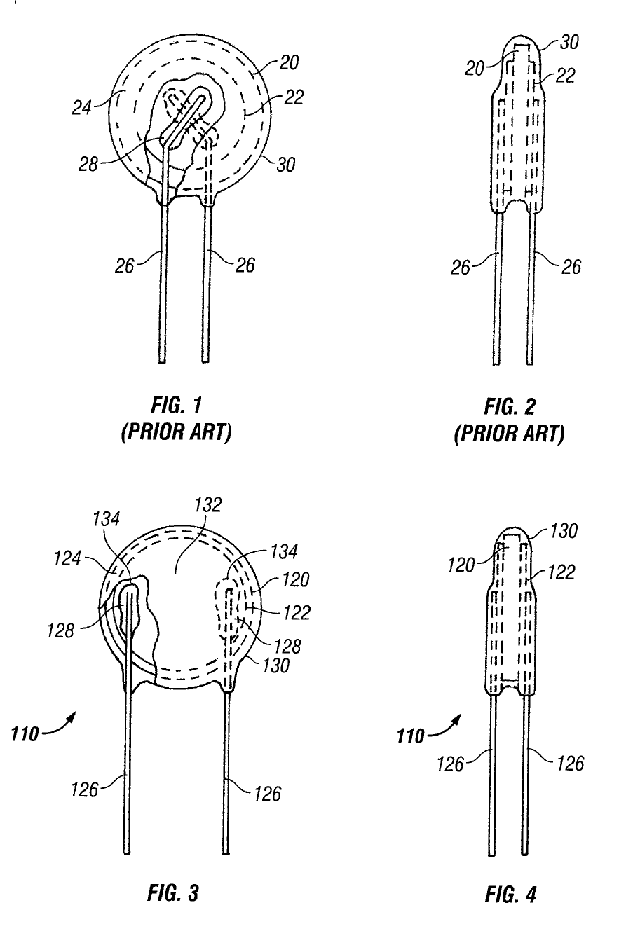

### DETAILED DESCRIPTION

One or more illustrative embodiments incorporating the invention disclosed herein are presented below. Not all features of an actual implementation are described or shown in this application for the sake of clarity. It is understood that the development of an actual embodiment incorporating the present invention, numerous implementation-specific decisions must be made to achieve the developer's goals, such as compliance with system-related, business-related and other constraints, which vary by implementation and from time to time. While a developer's efforts might be complex and time-consuming, such efforts would be, nevertheless, a routine undertaking for those of ordinary skill in the art having benefit of this disclosure.

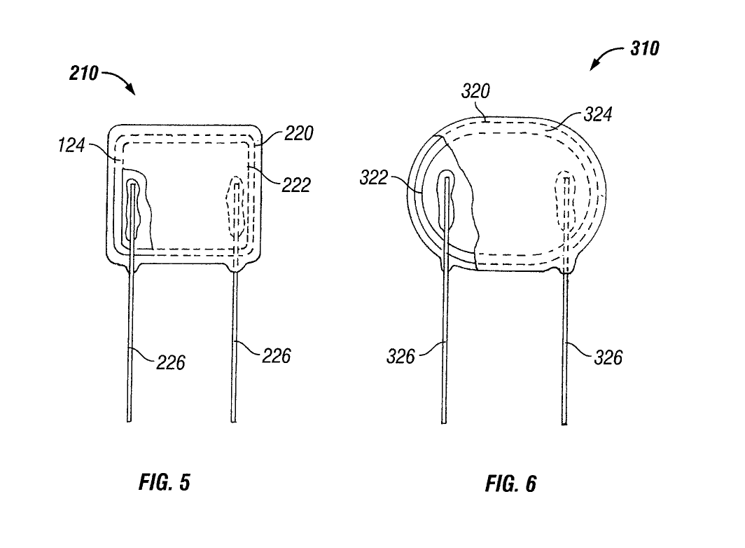

Referring to FIGS. 3 and 4, a MOV 110 of the present invention includes an inner core 120, electrodes 122, electrical lead wires 126, and protective coating 130. As shown in FIG. 3, the inner core 120 may be in the shape of a disc. Other shapes, however, are contemplated in the present invention including without limitation generally a square, rectangle, or oval, such as shown in FIGS. 5 and 6. The inner core 120 may be made of a zinc oxide with small additions of bismuth, cobalt, manganese and other metal oxides. The inner core 120 is fabricated by forming and sintering zinc oxide based powders into ceramic parts. The inner core 120 is designed such that excessive energy may be absorbed.

Electrodes 122 are deposited onto the two face surfaces 124, generally flat, of the disc-shaped ceramic inner core 120. There are several ways to deposit the electrodes 122 on the surfaces 124 of the inner core 120. One way is to depositing a thick film silver over the surfaces 124 of the inner core 120. Another way to deposit the electrodes 122 is by arc spraying metal materials such as aluminum and copper. As described in more detail below, the electrodes 22 are preferably placed on most if not all of the surfaces 124 of the inner core 120. This allows greater spacing between the two electrical leads 126.

Electrical leads 126 are then soldered to the electrodes 122 on each side of the inner core 120 with a soldering material at attachment points 128. Alternatively, the electrical leads 126 may be attached with a conductive adhesive known to those skilled in the art. Unlike the prior art, however, the electrical leads 126 are not attached to the center region 132 of the disc-shaped inner core 120. Instead, as shown in FIG. 3, the electrical leads 126 are mounted straight and to the outer regions 134 of the electrodes 122. The outer regions generally encompass a region of the outer 30% of the relevant cross sectional dimension of the electrodes 122. To allow the electrical leads 126 to be mounted to the outer regions 134 of the assembly of electrodes 122, it is preferable that the electrodes 22 be deposited on most if not all of the surfaces 124 of the inner core 120, that is generally at least a majority of the surface area. As shown in FIG. 3, the attachment points 128 for the electrical leads 126 are positioned at opposing outer regions 134 of the electrodes 122. By positioning the electrical leads 126 in this manner, the leads 125 are less likely to short if the MOV 110 physically destructs.

Finally, an epoxy-based coating 130 is then applied to the outer surfaces of the assembly of inner core 120, electrodes 122, and electrical leads 126. In normal operation of the MOV 110, the coating 130 minimizes the cracking of the inner core and maintains the assembly of the inner core 120, electrodes 122, and electrical lead wires 126.

Referring to FIGS. 5 and 6, alternative shapes of the presently disclosed device are illustrated. FIG. 5 shows a MOV 210 with an inner core 220 having surfaces 224 in the shape of a square. The electrodes 222 are deposited on the outer surfaces 224 of the inner core 220. The electrical leads 226 are then soldered or attached to the electrodes 222. Again, the electrical leads 226 are not bent toward the center region of the electrodes 222. Instead, the electrical leads 226 are attached the outer regions of the electrodes 222.

FIG. 6 shows a MOV 310 with an inner core 320 having surfaces 324 in the shape of an oval. The electrodes 322 are deposited on the outer surfaces 324 of the inner core 320. The electrical leads 326 are then soldered or attached to the electrodes 322. The electrical leads 326 are not bent toward the center region of the electrodes 322. Instead, the electrical leads 326 are attached the outer regions of the electrodes 322.

While the foregoing is directed to various embodiments of the present invention, other and further embodiments may be devised without departing from the basic scope thereof Other embodiments within the scope of the claims herein will be apparent to one skilled in the art from consideration of the specification and practice of the invention as disclosed herein. It is intended that the specification, together with the example, be considered exemplary only, with the scope and spirit of the invention being indicated by the claims which follow.

The various methods and embodiments of the invention can be included in combination with each other to produce variations of the disclosed methods and embodiments, as would be understood by those with ordinary skill in the art, given the understanding provided herein. Also, various aspects of the embodiments could be used in conjunction with each other to accomplish the understood goals of the invention. Also, the directions such as “top,” “bottom,” “left,” “right,” “upper,” “lower,” and other directions and orientations are described herein for clarity in reference to the figures and are not to be limiting of the actual device or system or use of the device or system. Unless the context requires otherwise, the word “comprise” or variations such as “comprises” or “comprising”, should be understood to imply the inclusion of at least the stated element or step or group of elements or steps or equivalents thereof, and not the exclusion of a greater numerical quantity or any other element or step or group of elements or steps or equivalents thereof The device or system may be used in a number of directions and orientations. Further, the order of steps can occur in a variety of sequences unless otherwise specifically limited. The various steps described herein can be combined with other steps, interlineated with the stated steps, and/or split into multiple steps. Additionally, the headings herein are for the convenience of the reader and are not intended to limit the scope of the invention.

Further, any references mentioned in the application for this patent as well as all references listed in the information disclosure originally filed with the application are hereby incorporated by reference in their entirety to the extent such may be deemed essential to support the enabling of the invention. However, to the extent statements might be considered inconsistent with the patenting of the invention, such statements are expressly not meant to be considered as made by the Applicant(s).

1. A varistor for protecting a system from abnormal energy transients, the varistor comprising:
a core having a first flat side and second flat side, the core further having opposing first and second outer side regions;
a first electrode deposited on the first side of the core, the first electrode having a center region and an outer region;
a second electrode deposited on the second side of the core, the second electrode having a center region and an outer regions;
a first electrical lead attached to the outer region of the first electrode at a first attachment point;
a second electrical lead attached to the outer region of the second electrode at a second attachment point;
wherein the first attachment point is adjacent the first outer side region of the core and the second attachment point is adjacent the second outer side region of the core.

2. The varistor of Claim I, wherein the first electrical lead and the second electrical lead are straight.

3. The varistor of claim 1, wherein said core is comprises metal oxide.

4. The varistor of claim 1, wherein said first and second sides are circular-shaped.

5. The varistor of claim 1, wherein said first and second sides are rectangular-shaped.

6. The varistor of claim 1, wherein said first and second sides are oval-shaped.

7. A varistor for protecting a system from abnormal energy transients, the varistor comprising:
a core having a first flat side and second flat side;
a first electrode deposited on the first side of the core, the first electrode having a center region and outer region;
a second electrode deposited on the second side of the core, the second electrode having a center region and two opposing outer regions;
a first electrical lead having a portion attached to the outer region of said first electrode at a first attachment point, the portion of the first electrical lead attached to the outer region being unbent; a second electrical lead having a portion attached to the outer region of said second electrode at a second attachment point, the portion of the second electrical lead having a portion attached to the outer region being unbent;
wherein the first attachment point and the second attachment point are positioned at opposite sides of the varistor.

8. The varistor of claim 7, wherein said core comprises metal oxide.

9. The varistor of claim 7, wherein said first and second sides are circular-shaped.

10. The varistor of claim 7, wherein said first and second sides are rectangular-shaped.

11. The varistor of claim 7, wherein said first and second sides are oval-shaped.

12. A method of making a varistor for protecting a system from abnormal energy transients, said method comprising:
providing a metal oxide core for absorbing energy transients, the core having a first flat side and a second flat side;
deposing a first electrode on the first side of the core, the first electrode having a center region and an outer region;
deposing a second electrode on the second side of the core, the second electrode having a center region and an outer region;
attaching a first electrical lead to the outer region of the first electrode;
attaching a second electrical lead to the outer region of the second electrode;
applying a protective coating over the metal oxide core, the first electrode, the second electrode and a portion of the first and second electrical leads.

13. The method of claim 12, wherein said metal oxide core is circular-shaped.

14. The method of claim 12, wherein said metal oxide core is rectangular-shaped.

15. The method of claim 12, wherein said metal oxide core is oval-shaped.

16. The method of claim 12, wherein the first electrical lead and the second electrical leads are straight.
